(19) United States
(12) Patent Application Publication
(10) Pub. No.: US 2026/0072779 A1
(43) Pub. Date: Mar. 12, 2026

(54) Method and System for Gap Detection

(71) Applicant: Rouslan Biletski, Kenmore, WA (US)

(72) Inventor: Rouslan Biletski, Kenmore, WA (US)

(21) Appl. No.: 19/325,841

(22) Filed: Sep. 11, 2025

Related U.S. Application Data
(60) Provisional application No. 63/693,376, filed on Sep. 11, 2024.

(51) Int. Cl. G06F 11/07

(52) U.S. Cl. CPC G06F 11/079; G06F 11/0724

(57) ABSTRACT

A method of determining and repairing gaps is presented involving noting errors and providing an indication of a set of possible causes of the errors. The set is then tested individually to identify which causes remain and which can be filtered. Remediation of those causes that remain is then optionally undertaken.

### FIELD OF THE INVENTION

The invention relates to artificial intelligence and more particularly to a method of improving communication through discovery gaps in knowledge.

### BACKGROUND

Artificial intelligence (AI) is a field in which computers “learn” and then behave with what appears to be intelligence. Today, AI is being applied in medicine, writing, self-driving cars, police work, and much more.

A known architecture for AI, the neural network, is a correlation engine that quickly maps input data onto output data providing a classification result in response to an input value. Systems of this type are often referred to as correlation engines. However, neural networks are trained systems and their operating principles, once trained, are not known. In essence, a neural network is a black box.

One known problem with self-training or self-updating correlation engines is a problem of convergence. When a correlation engine updates its training automatically, it often “improves” its correlation results based on its own previous results, right or wrong. A police AI tells police a location where crime is most likely to occur. Police then remain at that location and find crimes at that location because they are there. This reinforces the AI that that location is where crime occurs. Because police are not somewhere else, the data that results—a higher proportion of detected crimes at the location—is skewed by previous system generated results. Similarly, a movie recommendation engine that updates itself is most likely to see a lot of its own recommendations selected by users and therefore to reinforce/confirm its model, rather than to improve it. In fact, with each recommendation, such a system, becomes more and more certain of their limited suggestions.

At the forefront of artificial intelligence is a Large Language Model (LLM). An LLM is a large trainable system that is provided large stores of data for training to result in a system that responds to a natural language query in an informative way.

LLMs suffer several drawbacks. First, LLMs need to be trained often if they are to be aware of new events; second, LLMs need to be retrained each time their technology is updated; third, LLMs suffer what is termed “Hallucinations,” which are erroneous correlations leading to erroneous results; fourth, to fix hallucinations, LLMs require significant human tuning, and fifth, because LLMs are black box systems, tuning often introduces unknown and unpredictable errors.

It would be advantageous to provide a method of discovering what is missing from communications.

### SUMMARY OF EMBODIMENTS

In accordance with embodiments of the invention there is provided a method comprising: providing a first processor; providing an error from a first source and a first identifier of the first source to the processor; determining with the first processor a set of possible causes for the error; and storing by the first processor in association with the first identifier an indication of each possible cause of the set of possible causes as an indication of a possible gap.

Some embodiments comprise testing the first source against each possible cause of the set of possible causes and when a test shows no further error, eliminating said each possible cause from the set of possible causes to result in a reduced set of possible causes an indication of a possible gap.

In some embodiments the first source is a second other processor.

In some embodiments the first source is a second other processor in communication with the first processor.

In some embodiments the error is an error in communication.

In some embodiments the error is an error in result based on an electronic request.

In some embodiments the error is an error in result based on an electronic request, the electronic request sometimes resulting a result that is other than in error.

In some embodiments a gap is one of an indication of a failure of the first source and a failure of communication with the first source.

In some embodiments the first source is a person in communication with the first processor.

In some embodiments the error is an error in solving a mathematical equation.

In some embodiments the error is an error in a solution to a scientific problem.

In some embodiments a set of possible causes for the error is a comprehensive list of all potential errors that result in the error including mistake and skill deficiency.

In accordance with embodiments of the invention there is provided a method comprising: providing a set of sub-predictions for each of a plurality of first predictions; and upon one of the plurality of first predictions proving false, attributing to each sub-prediction related to the one an indication of a possible Gap.

Some embodiments comprise testing each sub-prediction related to the one to eliminate it as a possible Gap and once eliminated removing the indication.

In accordance with embodiments of the invention there is provided a method comprising: providing a first processor and a second other processor in communication with the first processor; providing data from the first processor to the second other processor for effecting a result; determining the result; when the result is incorrect, determining an error; determining with the first processor a set of possible causes for the error; and storing by the first processor in association with the second other processor an indication of each possible cause of the set of possible causes as an indication of a possible gap.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 illustrates a simplified diagram of skill related grades for two students;

FIG. 2 illustrates a simplified diagram for the two students with more detailed skills listed; and

FIG. 3 is a simplified flow diagram of a method of remediating gaps in student knowledge.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Large Language Model (LLM)—A large language model (LLM) is a computational model notable for its ability to achieve general-purpose language generation and other natural language processing tasks such as classification. Based on language models, LLMs acquire these abilities by learning statistical relationships from text documents during a computationally intensive self-supervised and semi-supervised training process.[1] LLMs can be used for text generation, a form of generative AI, by taking an input text and repeatedly predicting the next token or word
Artificial Intelligence (AI)—Artificial intelligence (AI), in its broadest sense, is intelligence exhibited by machines, particularly computer systems. It is a field of research in computer science that develops and studies methods and software that enable machines to perceive their environment and uses learning and intelligence to take actions that maximize their chances of achieving defined goals.[1] Such machines may be called AIs.
System 1: is a term coined by Daniel Kahneman and Amos Tversky to refer to the part of the brain/thought that draws conclusions quickly without detailed analysis. Often referred to as intuition or gut feel, System 1 provides important conclusions without detailed analysis.
System 2 is a term coined by Daniel Kahneman and Amos Tversky to refer to the part of the brain/thought that performs detailed analysis. Detailed analysis might be a process of mathematically calculating a value or a process of experimenting to see what works and what does not.
Training: is a process in learning systems wherein known answers are provided with input values in order for a correlation engine to learn to correlate those input values to the known answer.
Re-training: is a process in learning systems wherein a correlation engine that has been trained has an error in correlation and, as such, is further trained to correct such an error. Because most correlation engines are black box systems, it is unclear and not predictable what effect re-training will have on already trained and verified correlations. It is sometimes the case that retraining to fix one error leads to new and different errors.
Black box: is a term referring to a system whose characteristics are not known. A typical black box system maps an input signal to an output signal in a desired fashion that is inexplicable and only verifiable when forming a simple transform.
Fencing: is a term used to denote forming a boarder, either physical or virtual, that is known and verifiable.
Precision: is used herein to refer to a level of detail. Precision is separate from accuracy in the sense that something may be inaccurate (wrong) and still quite precise. Something may be very accurate and very imprecise. Most often when using models, accuracy and precision are dependent upon the circumstances.
Accuracy is used herein to refer to a level of correctness. Accuracy is separate from precision in the sense that something may be inaccurate (wrong) and still quite precise. Something may be very accurate and very imprecise. Most often when using models, accuracy varies dependent upon the circumstances. For example, the accuracy of an object determined with Newtonian dynamics is most often excellent, but begins to fail with increased velocity or decreased size.
Data Element is a single piece of data. A data element might be a file, a map, a location, or a number, etc. Data elements are typically passed or analysed as a single element. That said, a data element in one context may be several data elements in another context.

Human beings suffer an inability to communicate. This often is a result of a “gap,” something unknown on unshared that prevents functional communication. An example of a gap is two people who understand different languages. It is hard for them to communicate because neither speaks the language of the other and most words for the same concept are different. Less noticeable gaps occur when culture causes one person to understand something differently to another. In some cultures, being young is an insult. In others, it is a compliment. Knowing which is which is important to successful communication.

To address this problem, scientists often invent their own lexicon for their specific field. Thus, the term spin in Newtonian physics relates to an object rotating about an axis, but in quantum physics it is not that, but instead a characteristic of a particle with specific properties. Speaking to a quantum physicist about the spin of an electron as if it were Newtonian spin can lead to miscommunication.

That a same word, “spin,” is different in the two domains of the same field of study is not always simple to notice and often goes undetected. Undetected gaps lead to many problems in communication and in education.

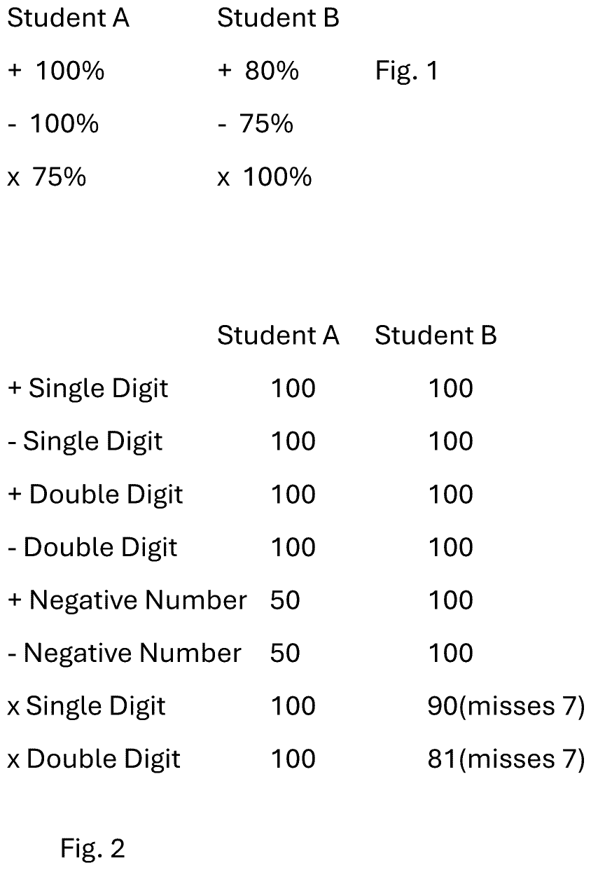

Referring to FIG. 1, a simplified diagram of mathematical skills is shown associated with two individuals. A first individual understands addition and subtraction but does not understand multiplication well. A second individual understands multiplication but is not so good at addition and subtraction. Both have grades that are between 70% and 80%. Both students will pass the year, but neither understands the material completely.

In communication, a failure of 20%-30% sometimes has no dramatic effect and other times results in a complete miscommunication. Further, any miscommunication might compound over time to make matters worse. It is easy to see how the students'lack of skill will affect them in the next year's mathematics classes.

Identifying specific gaps and specific issues is helpful to address miscommunications, remediate misunderstandings, and to move people closer to common understanding.

Referring to FIG. 2, shown is a simplified diagram of a set of skills making up addition and a set of skills making up multiplication. For each of the two individuals, skills they understand are identified. It is noteworthy that within addition and subtraction, one individual fails to understand adding and subtracting negative numbers and within multiplication the other individual does not know how to multiply by 7. Thus, within a skillset, each has deficiencies relating to specific subskills. Remediating these sub skills allows each individual to proceed with a complete understanding of the subskills and of the skills.

Similarly, for communicating complex topics such as quantum physics, a set of subskills is present and a meaningful teaching of quantum physics either requires the student to acquire all the subskills used in quantum physics or requires quantum physics to be explained using only the subskills that the student has mastered. For example, the student who cannot add negative numbers will be adversely affected when studying quantum physics. Thus, communication, to be successful, should use the minimum common skillset between the parties—between what is being communicated and the skillset of the recipient—or should upgrade the parties to a greater common skillset. In some situations, education uses the present skillset of the student and upgrades the student's skills in tandem, upgrading the student's skills to include those for quantum physics. Similarly when speaking with a child, one uses skills the child possesses but one hopes to upgrade the child's skills over time to make communication easier and more mature.

In intersystem communication, identifying “skills” of each system to allow for meaningful communication is important. One printer supports colour and requires some colour indicator—a flag: {colour, B&W}—while another printer is black and white and does not understand that parameter. A driver for a colour printer is adaptable to be used with a black and white printer by mapping the parameters accordingly or by supporting a default value for that parameter; a driver for a black and white printer can also be adapted to use with a colour printer in a similar fashion. That said, the adaptation is not always obvious because there is no colour parameter, though the file may originally be in colour and may print poorly in black and white. Thus, gaps present room for miscommunication that is not always simple to eliminate.

Gap detection allows for improved communication. It also allows for identification of deficiencies. Deficiency detection is core to education, automated design, and intersystem communication.

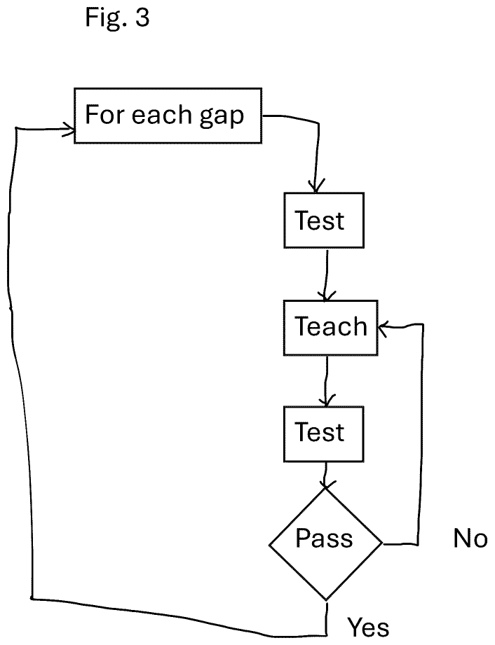

Referring to FIG. 3, shown is a simplified process for improving the math skills of both student A and student B. Here, instead of giving a lot of general problems to each student, student A is bombarded with teaching and problems relating to adding and subtracting negative numbers. This, in short order, brings the student to 100% knowledge of curriculum material. Student B is bombarded with problems and teaching of multiplication by 7, 70, 700, etc. Instead of improving grades by repeating the entire year or repeating lessons where performance was poor but that only relate to the problem tangentially, the students'gaps are addressed directly because they have been detected.

A method for detecting the gaps is shown in FIG. 3. Here, each student is given problems and responds with their work. Each incorrect answer or partial answer is mapped to all potential causes—carelessness, lack of skill A, lack of application of skill A to numeral X, etc. Thus, for Student A the determination with a first problem might be that they do not understand addition, do not understand addition of negative numbers, do not understand subtraction of 5, and/or are careless. The system understands that one possible cause does not exclude others. The student, Student A, is then provided problems focused on eliminating potential causes. It turns out that the student subtracts 5 correctly 3 times in a row, so that cause is eliminated and deleted from the list. Eventually, after numerous problems, the cause is determined to be addition of negative numbers, though carelessness always remains a possibility.

Once the potential cause is identified, remediation is undertaken to fill the Gap. Thus, Gaps once identified can be worked around or can be filled. When no incorrect answers are provided, the problems provided are increased in difficulty to try to identify gaps—mistakes—in responses.

Much more complex theories in mathematics are simply a construct of simpler math. The student who is poor at multiplying by 7, can understand statistics, but their answers in statistics will be incorrect approximately 10% of the time for single digit math and 19% for double digit math, etc. Thus, even advanced students have gaps and those gaps are identifiable, though they will be included in a long list of potential gaps; isolated; and remediated. In the example of statistics, the student's potential gaps might look like: calculate average, multiply, multiply by 7, divide, add, add list, add two-digit numbers, multiply two-digit numbers, divide, parenthesis/order of operations, etc. Though the list is longer, the principle and method to then filter the list and remediate the gaps remains the same.

Historically, gap analysis has been a function of curricula and specified skills. This is very limited because skills are enumerated manually and given names, which iis inherently prone to omission. The skill of two-digit addition includes adding a two-digit number to a one-digit number, adding a two-digit number to a two-digit number, and adding two two-digit numbers resulting in a carry operation. This list is absent all the skills contained therein, carrying from the lower order digit, carrying from the higher order digit, adding each individual digit or each digit pair. Thus, adding two-digit numbers encompasses well over 10,000 individually identifiable skills.

Manual enumeration is very difficult, but computer enumeration is not. A computer can map each error onto all possible causes. All causes will include the specific and then generalisations. A person who answers 100 one-digit addition problems incorrectly out of 100 problems likely does not know each pairing for addition and likely dies not understand addition. Identifying the gaps where individual mistakes aggregate helps the system to map misunderstanding and to remediate or avoid, as the situation dictates.

For systems, a similar approach is supported, but the testing is more automated in nature. For example, a printer is sent a plurality of codes and results are analysed until a communication protocol is established. Preferably, a printer driver is available and the system analyses the driver to limit a search space for gaps. Gaps include missing information, information in different formats, information consolidated or separated, and so forth. For example, colour might be represented as a flag—colour or black and white—or within the data wherein black and white documents are just that and a document print engine converts the document provided to the printer to a colour palette of the printer. Filtering or translating information at different stages often results in gaps.

Designing a new interface for a printer based on gap detection and gap filling allows said printer to be used by different operating systems that previously did not support the printer.

Of course, similar processes apply to improving user interfaces or designing user interfaces; translating software for use with different processors, operating systems, computers, networks, etc.; merging software applications; dividing software applications; upgrading software applications by filling in gaps; repurposing software. As an example, a driver written for one robot is adaptable to controlling another robot once gaps are detected and mapping of the control data is established. Still, even with complete mapping, one of the robots may have additional functions that are not present in the original driver. For example, the new robot has stereo vision whereas the original robot has a single camera. Gaps of this type are correctable in a default fashion, have human intervention to determine remediation, or rely on artificial intelligence to optimise filling the gap.

Of note, gap detection typically relies on feedback. A message send with no acknowledgement is resent until acknowledgement is received; a database operation is verified against a database to determine that it operates as expected; a printout is scanned to verify the printout against expectations. Gaps are determined based on unexpected results. For example, gaps are detected based on inconsistencies between expectation and measurement. A printed page does not look as it is supposed to look or the orbit of mercury is not as predicted by Newtonian physics, this leads to a “gap” being detected. Some gaps are immediately understood. Others are merely known gaps without explanation. Possible explanations are then formulated to try to test and filter each explanation to arrive at reasonable options to remediate/fill the identified gap. As such, gaps are useful for education, communication, translation and adaptation; Gaps are also useful for learning and exploration.

Sometimes gaps arise from internal issues—the printer driver is not “correct.” In these situations, the computer system itself can remediate the gap, test the result and report or implement the gap and remediation. Other times, the gap is with an external system and requires co-operation for adequate remediation. In situations where the other system is inaccessible or cannot be remediated, the computer system adjusts its operation to result in an adequate or “best” operational result.

Numerous other embodiments may be envisaged without departing from the scope of the invention.

What is claimed is:

1. A method comprising:
providing a first processor;
providing an error from a first source and a first identifier of the first source to the processor;
determining with the first processor a set of possible causes for the error; and
storing by the first processor in association with the first identifier an indication of each possible cause of the set of possible causes as an indication of a possible gap.

2. A method according to claim 1 comprising testing the first source against each possible cause of the set of possible causes and when a test shows no further error, eliminating said each possible cause from the set of possible causes to result in a reduced set of possible causes an indication of a possible gap.

3. A method according to claim 2 wherein the first source is a second other processor.

4. A method according to claim 2 wherein the first source is a second other processor in communication with the first processor.

5. A method according to claim 4 wherein the error is an error in communication.

6. A method according to claim 4 wherein the error is an error in result based on an electronic request.

7. A method according to claim 4 wherein the error is an error in result based on an electronic request, the electronic request sometimes resulting a result that is other than in error.

8. A method according to claim 1 wherein a gap is one of an indication of a failure of the first source and a failure of communication with the first source.

9. A method according to claim 2 wherein the first source is a person in communication with the first processor.

10. A method according to claim 9 wherein the error is an error in solving a mathematical equation.

11. A method according to claim 10 wherein a set of possible causes for the error is a comprehensive list of all potential errors that result in the error including mistake and skill deficiency.

12. A method according to claim 9 wherein the error is an error in a solution to a scientific problem.

13. A method according to claim 12 wherein a set of possible causes for the error is a comprehensive list of all potential errors that result in the error including mistake and skill deficiency.

14. A method comprising:
providing a set of sub-predictions for each of a plurality of first predictions; and
upon one of the plurality of first predictions proving false, attributing to each sub-prediction related to the one an indication of a possible Gap.

15. A method according to claim 14 comprising testing each sub-prediction related to the one to eliminate it as a possible Gap and once eliminated removing the indication.

16. A method comprising:
providing a first processor and a second other processor in communication with the first processor;
providing data from the first processor to the second other processor for effecting a result;
determining the result;
when the result is incorrect, determining an error;
determining with the first processor a set of possible causes for the error; and
storing by the first processor in association with the second other processor an indication of each possible cause of the set of possible causes as an indication of a possible gap.
